(19) United States
(12) Patent Application Publication
(10) Pub. No.: US 2026/0253528 A1
(43) Pub. Date: Aug. 27, 2026

(54) DISPLAY DRIVER INTEGRATED CIRCUIT STRUCTURE

(71) Applicant: Powerchip Semiconductor Manufacturing Corporation, Hsinchu (TW)

(72) Inventors: Shou-Zen Chang, Hsinchu City (TW); Chuen-Jiunn Shyu, Hsinchu City (TW); Chun-Cheng Chen, Changhua County (TW); Wei-Shan Chiang, Hsinchu (TW)

(73) Assignee: Powerchip Semiconductor Manufacturing Corporation, Hsinchu (TW)

(21) Appl. No.: 19/176,106

(22) Filed: Apr. 10, 2025

(30) Foreign Application Priority Data
Feb. 21, 2025 (TW) 114106487

(51) Int. Cl. G09G 3/20

(52) U.S. Cl. CPC G09G 3/2092; G09G 2300/0408; G09G 2300/0857; G09G 2310/0267; G09G 2310/0275; G09G 2310/0286

(57) ABSTRACT

A display driver integrated circuit structure includes first and second chips. The first chip includes first semiconductor devices including a scan driver, a data driver, a gamma adjuster, a power circuit, an OTP memory, a MTP memory, a digital I/O circuit, an analog I/O circuit, and a power I/O circuit. The second chip includes second semiconductor devices including a panel display controller, a power controller, a high-speed interface controller, a high-speed interface receiver, a high-speed interface command decoder, a low-speed interface controller, a low-speed interface receiver, a low-speed interface command decoder, a register read controller, a register write controller, a SRAM controller, a SRAM bit-cell, an OTP memory controller, a MTP memory controller, an OTP memory bit-cell, a MTP memory bit-cell, a shift register of the scan driver, a shift register of the data driver, a latch of the scan driver, and a latch of the data driver.

### CROSS-REFERENCE TO RELATED APPLICATION

This application claims the priority benefit of Taiwan application serial no. 114106487, filed on Feb. 21, 2025. The entirety of the above-mentioned patent application is hereby incorporated by reference herein and made a part of this specification.

### BACKGROUND

### Technical Field po The invention relates to a semiconductor structure, and particularly relates to a display driver integrated circuit structure.

### Description of Related Art

The display driver integrated circuit (DDI) structure requires the use of the high-voltage device, the medium-voltage device, and the low-voltage device. As the semiconductor device continues to shrink, it becomes more difficult to manufacture the high-voltage device, the medium-voltage device, and the low-voltage device on the same single chip, which will lead to a decrease in the reliability of the display driver integrated circuit (DDI) structure and an increase in cost. Therefore, how to improve the reliability of the display driver integrated circuit structure and reduce the manufacturing cost of the display driver integrated circuit structure is the goal of continuous efforts.

### SUMMARY

The invention provides a display driver integrated circuit structure, which has higher reliability and lower manufacturing cost.

The invention provides a display driver integrated circuit structure, which includes a first chip and a second chip. The first chip includes first semiconductor devices. The first semiconductor devices include a scan driver, a data driver, a gamma adjuster, a power circuit, a one-time programmable (OTP) memory, a multiple-time programmable (MTP) memory, a digital input-output (I/O) circuit, an analog I/O circuit, and a power I/O circuit. The second chip is bonded to the first chip. The second chip includes second semiconductor devices. The second semiconductor devices includes a panel display controller, a power controller, a high-speed interface controller, a high-speed interface receiver, a high-speed interface command decoder, a low-speed interface controller, a low-speed interface receiver, a low-speed interface command decoder, a register read controller, a register write controller, a static random access memory (SRAM) controller, a SRAM bit-cell, an OTP memory controller, a MTP memory controller, an OTP memory bit-cell, a MTP memory bit-cell, a shift register of the scan driver, a shift register of the data driver, a latch of the scan driver, and a latch of the data driver.

According to an embodiment of the invention, in the display driver integrated circuit structure, the first semiconductor devices may further include sensors.

According to an embodiment of the invention, in the display driver integrated circuit structure, the second semiconductor devices may further include at least one of a SRAM read assistant, a SRAM write assistant, and a sensor controller.

According to an embodiment of the invention, in the display driver integrated circuit structure, the first semiconductor devices may include high-voltage devices, medium-voltage devices, or a combination thereof.

According to an embodiment of the invention, in the display driver integrated circuit structure, the second semiconductor devices may include low-voltage devices.

According to an embodiment of the invention, in the display driver integrated circuit structure, the breakdown voltages of the first semiconductor devices may be higher than the breakdown voltages of the second semiconductor devices.

According to an embodiment of the invention, in the display driver integrated circuit structure, a minimum pitch of the first semiconductor devices may be greater than a minimum pitch of the second semiconductor devices.

According to an embodiment of the invention, in the display driver integrated circuit structure, the second chip may be hybrid-bonded to the first chip.

According to an embodiment of the invention, in the display driver integrated circuit structure, the second chip may be fusion-bonded to the first chip.

According to an embodiment of the invention, in the display driver integrated circuit structure, the first chip and the second chip may be stacked in a manner of a face-to-back configuration.

According to an embodiment of the invention, in the display driver integrated circuit structure, the first chip and the second chip may be stacked in a manner of a face-to-face configuration.

According to an embodiment of the invention, in the display driver integrated circuit structure, the first chip and the second chip may be stacked in a manner of a back-to-back configuration.

Based on the above description, a display driver integrated circuit structure according to the invention includes a first chip and a second chip. The first chip includes first semiconductor devices. The first semiconductor devices include a scan driver, a data driver, a gamma adjuster, a power circuit, an OTP memory, a MTP memory, a digital I/O circuit, an analog I/O circuit, and a power I/O circuit. The second chip is bonded to the first chip. The second chip includes second semiconductor devices. The second semiconductor devices includes a panel display controller, a power controller, a high-speed interface controller, a high-speed interface receiver, a high-speed interface command decoder, a low-speed interface controller, a low-speed interface receiver, a low-speed interface command decoder, a register read controller, a register write controller, a SRAM controller, a SRAM bit-cell, an OTP memory controller, a MTP memory controller, an OTP memory bit-cell, a MTP memory bit-cell, a shift register of the scan driver, a shift register of the data driver, a latch of the scan driver, and a latch of the data driver. Therefore, the scan driver, the data driver, the gamma adjuster, the power circuit, the OTP memory, the MTP memory, the digital I/O circuit, the analog I/O circuit, and the power I/O circuit having the same or similar minimum pitch can be located on the same first chip. In addition, the panel display controller, the power controller, the high-speed interface controller, the high-speed interface receiver, the high-speed interface command decoder, the low-speed interface controller, the low-speed interface receiver, the low-speed interface command decoder, the register read controller, the register write controller, the SRAM controller, the SRAM bit-cell, the OTP memory controller, the MTP memory controller, the OTP memory bit-cell, the MTP memory bit-cell, the shift register of the scan driver, the shift register of the data driver, the latch of the scan driver, and the latch of the data driver having the same or similar minimum pitch can be located on the same second chip. In this way, the process complexity of the first chip and the process complexity of the second chip can be reduced, thereby improving the reliability of the display driver integrated circuit structure and reducing the manufacturing cost of the display driver integrated circuit structure. Furthermore, the size of the display driver integrated circuit structure can be reduced, thereby reducing the space required to attach the display driver integrated circuit structure to the electronic device (e.g., display or smart phone).

In order to make the aforementioned and other objects, features and advantages of the invention comprehensible, several exemplary embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display driver integrated circuit structure according to some embodiments of the invention.

FIG. 2 is a schematic diagram of an electronic device according to some embodiments of the invention.

### DESCRIPTION OF THE EMBODIMENTS

The embodiments are described in detail below with reference to the accompanying drawings, but the embodiments are not intended to limit the scope of the invention. For the sake of easy understanding, the same components in the following description will be denoted by the same reference symbols. In addition, the drawings are for illustrative purposes only and are not drawn to the original dimensions. In fact, the dimensions of the various features may be arbitrarily increased or reduced for clarity of discussion.

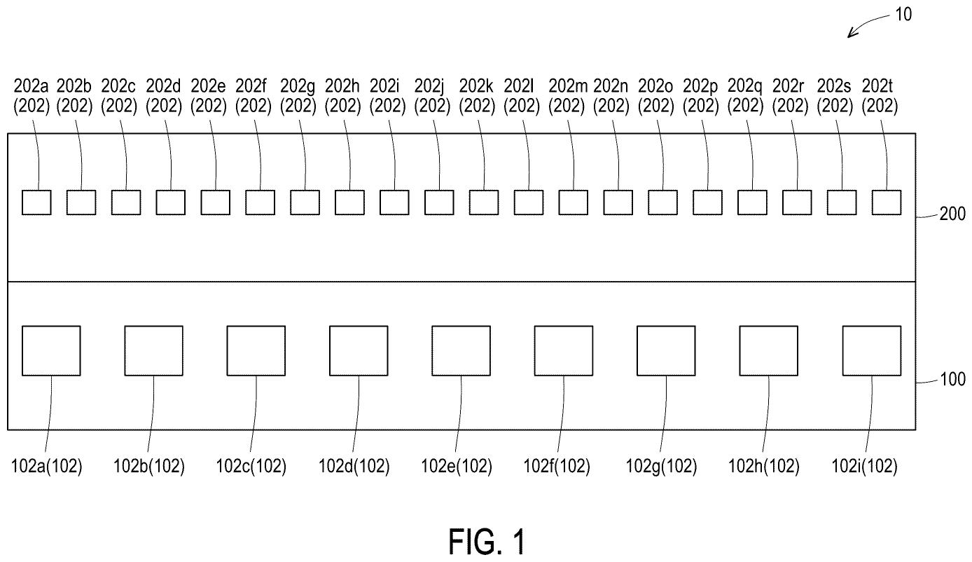

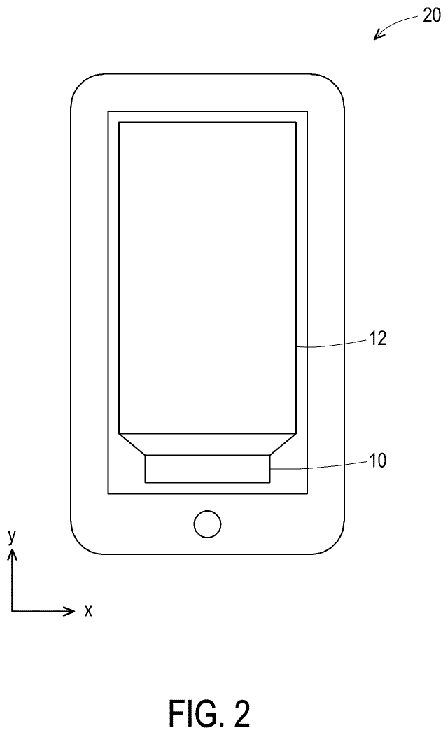

FIG. 1 is a schematic diagram of a display driver integrated circuit structure according to some embodiments of the invention. FIG. 2 is a schematic diagram of an electronic device according to some embodiments of the invention.

Referring to FIG. 1, a display driver integrated circuit structure 10 includes a chip 100 and a chip 200. The display driver integrated circuit structure 10 may be applied to the electronic device (e.g., display or smart phone).

The chip 100 includes semiconductor devices 102. The semiconductor devices 102 include a scan driver, a data driver, a gamma adjuster, a power circuit, an OTP memory, a MTP memory, a digital I/O circuit, an analog I/O circuit, and a power I/O circuit. In some embodiments, the semiconductor devices 102 may further include sensors. In addition, in FIG. 1, the number of the semiconductor devices 102 is for illustration only, and the invention is not limited thereto.

The chip 200 is bonded to the chip 100. Therefore, the chip 200 may be electrically connected to the chip 100, and the semiconductor device 202 may be electrically connected to the semiconductor device 102. In some embodiments, the semiconductor device 102 and the semiconductor device 202 may be electrically connected to each other by conductive components such as an interconnect structure, a through-silicon via (TSV), and/or a pad. In some embodiments, the chip 200 may be hybrid-bonded to the chip 100. In some embodiments, the chip 200 may be fusion-bonded to the chip 100. In some embodiments, the chip 100 and the chip 200 may be stacked in a manner of a face-to-back configuration. In some embodiments, the chip 100 and the chip 200 may be stacked in a manner of a face-to-face configuration. In some embodiments, the chip 100 and the chip 200 may be stacked in a manner of a back-to-back configuration. In addition, in FIG. 1, the number of the semiconductor devices 202 is for illustration only, and the invention is not limited thereto.

The chip 200 includes semiconductor devices 202. The semiconductor devices 202 include a panel display controller, a power controller, a high-speed interface controller, a high-speed interface receiver, a high-speed interface command decoder, a low-speed interface controller, a low-speed interface receiver, a low-speed interface command decoder, a register read controller, a register write controller, a SRAM controller, a SRAM bit-cell, an OTP memory controller, a MTP memory controller, an OTP memory bit-cell, a MTP memory bit-cell, a shift register of the scan driver, a shift register of the data driver, a latch of the scan driver, and a latch of the data driver. In some embodiments, the semiconductor devices 202 may further include at least one of a SRAM read assistant, a SRAM write assistant, and a sensor controller.

In some embodiments, the semiconductor devices 102 may include high-voltage devices, medium-voltage devices, or a combination thereof. In some embodiments, the semiconductor devices 202 may include low-voltage devices. In some embodiments, the breakdown voltages of the semiconductor devices 102 may be higher than the breakdown voltages of the semiconductor devices 202. In some embodiments, a minimum pitch of the semiconductor devices 102 may be greater than a minimum pitch of the semiconductor devices 202. In the present embodiment, the pitch may be defined as the sum of the line width and the line spacing.

In some embodiments, the display driver integrated circuit structure 10 may be applied in an electronic device 20. In some embodiments, the electronic device 20 is, for example, a display or a smart phone, but the invention is not limited thereto. In the present embodiment, the electronic device 20 is, for example, a smart phone. As shown in FIG. 2, the electronic device 20 may include the display driver integrated circuit structure 10 and a panel 12. The display driver integrated circuit structure 10 may be electrically connected to the panel 12. In some embodiments, the panel 12 is, for example, an organic light emitting diode (OLED) panel or a liquid crystal display (LCD) panel.

Based on the above embodiments, the display driver integrated circuit structure 10 includes the chip 100 and the chip 200. The chip 100 includes the semiconductor devices 102. The semiconductor devices 102 include the scan driver, the data driver, the gamma adjuster, the power circuit, the OTP memory, the MTP memory, the digital I/O circuit, the analog I/O circuit, and the power I/O circuit. The chip 200 is bonded to the chip 100. The chip 200 includes the semiconductor devices 202. The semiconductor devices 202 include the panel display controller, the power controller, the high-speed interface controller, the high-speed interface receiver, the high-speed interface command decoder, the low-speed interface controller, the low-speed interface receiver, the low-speed interface command decoder, the register read controller, the register write controller, the SRAM controller, the SRAM bit-cell, the OTP memory controller, the MTP memory controller, the OTP memory bit-cell, the MTP memory bit-cell, the shift register of the scan driver, the shift register of the data driver, the latch of the scan driver, and the latch of the data driver. Therefore, the scan driver, the data driver, the gamma adjuster, the power circuit, the OTP memory, the MTP memory, the digital I/O circuit, the analog I/O circuit, and the power I/O circuit having the same or similar minimum pitch can be located on the same chip 100. In addition, the panel display controller, the power controller, the high-speed interface controller, the high-speed interface receiver, the high-speed interface command decoder, the low-speed interface controller, the low-speed interface receiver, the low-speed interface command decoder, the register read controller, the register write controller, the SRAM controller, the SRAM bit-cell, the OTP memory controller, the MTP memory controller, the OTP memory bit-cell, the MTP memory bit-cell, the shift register of the scan driver, the shift register of the data driver, the latch of the scan driver, and the latch of the data driver having the same or similar minimum pitch can be located on the same chip 200. In this way, the process complexity of the chip 100 and the process complexity of the chip 200 can be reduced, thereby improving the reliability of the display driver integrated circuit structure 10 and reducing the manufacturing cost of the display driver integrated circuit structure 10. Furthermore, the size of the display driver integrated circuit structure 10 can be reduced, thereby reducing the space required to attach the display driver integrated circuit structure 10 to the electronic device 20 (e.g., display or smart phone). For example, as shown in FIG. 2, the size of the display driver integrated circuit structure 10 on the Y axis can be reduced, thereby reducing the space required to attach the display driver integrated circuit structure 10 to the electronic device 20. Moreover, the X-axis direction may be the width extension direction of the electronic device 20, and the Y-axis direction may be the length extension direction of the electronic device 20.

In summary, a display driver integrated circuit structure of the aforementioned embodiments includes a first chip and a second chip. The first chip includes first semiconductor devices. The first semiconductor devices include a scan driver, a data driver, a gamma adjuster, a power circuit, an OTP memory, a MTP memory, a digital I/O circuit, an analog I/O circuit, and a power I/O circuit. The second chip is bonded to the first chip. The second chip includes second semiconductor devices. The second semiconductor devices includes a panel display controller, a power controller, a high-speed interface controller, a high-speed interface receiver, a high-speed interface command decoder, a low-speed interface controller, a low-speed interface receiver, a low-speed interface command decoder, a register read controller, a register write controller, a SRAM controller, a SRAM bit-cell, an OTP memory controller, a MTP memory controller, an OTP memory bit-cell, a MTP memory bit-cell, a shift register of the scan driver, a shift register of the data driver, a latch of the scan driver, and a latch of the data driver. Therefore, the scan driver, the data driver, the gamma adjuster, the power circuit, the OTP memory, the MTP memory, the digital I/O circuit, the analog I/O circuit, and the power I/O circuit having the same or similar minimum pitch can be located on the same first chip. In addition, the panel display controller, the power controller, the high-speed interface controller, the high-speed interface receiver, the high-speed interface command decoder, the low-speed interface controller, the low-speed interface receiver, the low-speed interface command decoder, the register read controller, the register write controller, the SRAM controller, the SRAM bit-cell, the OTP memory controller, the MTP memory controller, the OTP memory bit-cell, the MTP memory bit-cell, the shift register of the scan driver, the shift register of the data driver, the latch of the scan driver, and the latch of the data driver having the same or similar minimum pitch can be located on the same second chip. In this way, the process complexity of the first chip and the process complexity of the second chip can be reduced, thereby improving the reliability of the display driver integrated circuit structure and reducing the manufacturing cost of the display driver integrated circuit structure. Furthermore, the size of the display driver integrated circuit structure can be reduced, thereby reducing the space required to attach the display driver integrated circuit structure to the electronic device (e.g., display or smart phone).

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A display driver integrated circuit structure, comprising:
a first chip comprising first semiconductor devices, wherein the first semiconductor devices comprise a scan driver, a data driver, a gamma adjuster, a power circuit, a one-time programmable (OTP) memory, a multiple-time programmable (MTP) memory, a digital input-output (I/O) circuit, an analog I/O circuit, and a power I/O circuit; and
a second chip bonded to the first chip and comprising second semiconductor devices, wherein the second semiconductor devices comprise a panel display controller, a power controller, a high-speed interface controller, a high-speed interface receiver, a high-speed interface command decoder, a low-speed interface controller, a low-speed interface receiver, a low-speed interface command decoder, a register read controller, a register write controller, a static random access memory (SRAM) controller, a SRAM bit-cell, an OTP memory controller, a MTP memory controller, an OTP memory bit-cell, a MTP memory bit-cell, a shift register of the scan driver, a shift register of the data driver, a latch of the scan driver, and a latch of the data driver.

2. The display driver integrated circuit structure according to claim 1, wherein the first semiconductor devices further comprise sensors.

3. The display driver integrated circuit structure according to claim 1, wherein the second semiconductor devices further comprise at least one of a SRAM read assistant, a SRAM write assistant, and a sensor controller.

4. The display driver integrated circuit structure according to claim 1, wherein the first semiconductor devices comprise high-voltage devices, medium-voltage devices, or a combination thereof.

5. The display driver integrated circuit structure according to claim 4, wherein the second semiconductor devices comprise low-voltage devices.

6. The display driver integrated circuit structure according to claim 1, wherein breakdown voltages of the first semiconductor devices are higher than breakdown voltages of the second semiconductor devices.

7. The display driver integrated circuit structure according to claim 1, wherein a minimum pitch of the first semiconductor devices is greater than a minimum pitch of the second semiconductor devices.

8. The display driver integrated circuit structure according to claim 1, wherein the second chip is hybrid-bonded to the first chip.

9. The display driver integrated circuit structure according to claim 1, wherein the second chip is fusion-bonded to the first chip.

10. The display driver integrated circuit structure according to claim 1, wherein the first chip and the second chip are stacked in a manner of a face-to-back configuration.

11. The display driver integrated circuit structure according to claim 1, wherein the first chip and the second chip are stacked in a manner of a face-to-face configuration.

12. The display driver integrated circuit structure according to claim 1, wherein the first chip and the second chip are stacked in a manner of a back-to-back configuration.
